(19) United States
(12) Patent Application Publication
(10) Pub. No.: US 2020/0398614 A1
(43) Pub. Date: Dec. 24, 2020

(54) NON-PNEUMATIC TIRE

(71) Applicant: Hebei Wanda Tyre Co., Ltd, Hebei (CN)

(72) Inventors: Peng GENG, Tianjin (CN); Qinghua ZHANG, Tianjin (CN); Chuan LIU, Tianjin (CN)

(73) Assignee: Hebei Wanda Tyre Co., Ltd, Hebei (CN)

(21) Appl. No.: 16/880,903

(22) Filed: May 21, 2020

(30) Foreign Application Priority Data
Jun. 21, 2019 (CN) 201910543104.X

(51) Int. Cl. B60C 17/00; B60C 13/00; B60C 15/00

(52) U.S. Cl. CPC B60C 17/0036; B60C 2017/0081; B60C 15/0009; B60C 13/002

(57) ABSTRACT

A non-pneumatic tire includes beads, apexes, an inner liner, a cushion ply, a tread rubber, sidewall rubbers, and a first carcass ply; and further includes sidewall support layers and a crown support layer. The sidewall support layers are located at the locations of sidewalls and interposed between the inner liner and the first carcass ply. The crown support layer is located at the location of a crown, and interposed between the inner liner and the first carcass ply or between the first carcass ply and the cushion ply. Both ends of the crown support layer respectively extend toward the sidewalls and are partly overlapped with the sidewall support layers.

### CROSS-REFERENCE TO RELATED APPLICATION

This application claims the priority benefit of China application No. 201910543104.X, filed on Jun. 21, 2019. The entirety of the above-mentioned patent application is hereby incorporated by reference herein and made a part of this specification.

### BACKGROUND

### Technical Field

The present application relates to the technical field of tire, in particular to a non-pneumatic tire.

### Description of Related Art

Conventional non-pneumatic tires mainly includes solid tire and honeycomb tire. These two kinds of tires do not need to be inflated, and can achieve a supporting function and a cushioning function only using its own material and structure. However, the two kinds of tires have the following disadvantages.

Because solid tires are supported by inner rubber compounds, the weight of the whole tire is heavier, the elasticity of the tire is poor, the cushioning effect during driving is poor, and the assembly of the tire and the rim is not convenient.

The honeycomb tire absorbs and buffers the deformation during driving through the internal hollow design. Although the weight is reduced, the air convection in the gaps of hollow honeycomb structure will significantly increase the noise during the driving. During emergency braking, the rim is easily damaged due to deformation of the tire. In addition, since the hollow support parts of the rim are easily damaged by collisions, the tires need to be replaced. The tire has a small ground contact area, which does not provide enough traction and good comfort.

### SUMMARY

According to an embodiment, there is provided a non-pneumatic tire including beads, apexes, an inner liner, a cushion ply, a tread rubber, sidewall rubbers and a first carcass ply. The non-pneumatic tire further includes sidewall support layers and a crown support layer. The sidewall support layers are located at locations of sidewalls of the non-pneumatic tire and interposed between the inner liner and the first carcass ply. The crown support layer is located at the location of a crown of the non-pneumatic tire, and interposed between the inner liner and the first carcass ply or between the first carcass ply and the cushion ply, and both ends of the crown support layer respectively extend toward the two sidewalls.

According to another embodiment, the two ends of the crown support layer are respectively partly overlapped with the sidewall support layers.

According to another embodiment, the thickness of the crown support layer is in a range of 2-10 mm.

According to another embodiment, the non-pneumatic tire further comprises a second carcass ply, and the second carcass ply is arranged between the first carcass ply and the cushion ply. In this case, the crown support layer can be interposed between the inner liner and the first carcass ply, between the first carcass ply and the second carcass ply, or between the second carcass ply and the cushion ply.

According to another embodiment, the first carcass ply, the second carcass ply and the cushion ply are arranged to have at least one layer of cord each.

According to another embodiment, both ends of the first carcass ply respectively extend to surround the beads from the inner sides of the beads and respectively continue to extend upward to wrap the beads and the apexes. Both ends of the second carcass ply respectively extend from both sides of the crown toward the two sidewalls to beneath the beads, or extend toward the insides of the beads to surrounds the beads.

In one embodiment of the present application, the apexes are respectively partly overlapped with the sidewall support layers with the first carcass ply arranged between them.

According to another embodiment, when the first carcass ply has at least two layers of carcass cords, the at least two layers of carcass cords are mutually crosswise arranged.

According to another embodiment, when the second carcass ply has at least two layers of carcass cords, the at least two layers of carcass cords are mutually crosswise arranged, and an inner layer of carcass cord of the second carcass ply and an outer layer of carcass cord of the first carcass ply are mutually crosswise arranged.

According to another embodiment, when the cushion ply has at least two layers of cushion cords, the at least two layers of cushion cords are mutually crosswise arranged, and an inner layer of cushion cord and an outer layer of carcass cord of the second carcass ply are mutually crosswise arranged.

### BRIEF DESCRIPTION OF THE DRAWINGS

FIG. 1 is a cross-sectional view of a non-pneumatic tire of embodiment I of the present application;

FIG. 2 is a partial enlarged schematic view of FIG. 1;

FIG. 3 is a cross-sectional view of a non-pneumatic tire of embodiment II of the present application;

FIG. 4 is a partial enlarged schematic view of FIG. 3;

FIG. 5 is a cross-sectional view of a non-pneumatic tire of embodiment IV of the present application;

FIG. 6 is a cross-sectional view of a non-pneumatic tire of embodiment V of the present application;

FIG. 7 is a view of the pressure distribution of a non-pneumatic tire of the present application in a normal use state;

FIG. 8 is a view of the pressure distribution of an existing non-pneumatic tire in a normal use state; and

FIG. 9 is a view of the pressure distribution of an existing honeycomb tire.

### DESCRIPTION OF THE EMBODIMENTS

According to an aspect of the invention, there is provided a non-pneumatic tire with lighter weight, less noise, and cushioning performance similar to that of pneumatic tires.

The material of a cushion ply of the non-pneumatic tire includes but is not limited to nylon, polyester fiber, or aramid. The material of a sidewall support layer of the non-pneumatic tire includes but is not limited to rubber and polyurethane. The material of a crown support layer of the non-pneumatic tire includes but is not limited to rubber and polyurethane. The material of a cushion ply of the non-pneumatic tire includes but is not limited to nylon, polyester fiber, aramid, or steel wire. The sidewall rubbers and the tread rubber are formed of different rubber compounds (materials), such that the hardness of the sidewall rubbers is higher than that of the tread rubber, thereby achieving certain supporting performance.

The non-pneumatic tire of this application is applicable to all terrain vehicle (ATV), lawnmower, utility vehicle and the like.

The beneficial effects of the present application are as follow.

1. The contour of the ground contact portion of the non-pneumatic tire of the present application is similar to that of a pneumatic tire. The ground contact area is larger. Therefore, the non-pneumatic tire of the present application provides a cushioning performance similar to that of a pneumatic tire, excellent comfort and sufficient traction.

2. Compared with a honeycomb tire, the non-pneumatic tire of the present application has lower pressure on the ground and less wear during use of the non-pneumatic tire, thus increasing service life. In addition, the closed inner space of the non-pneumatic tire of the present application can avoid generating large noise.

3. Since the non-pneumatic tire of the present application has a hollow space formed between the inner liner and the rim, the weight of the non-pneumatic tire is greatly reduced compared to a solid non-pneumatic tire.

4. Since the non-pneumatic tire of the present application has a bead design similar to that of a pneumatic tire, it is more convenient to assemble the non-pneumatic tire to the rim or disassemble the non-pneumatic tire from the rim.

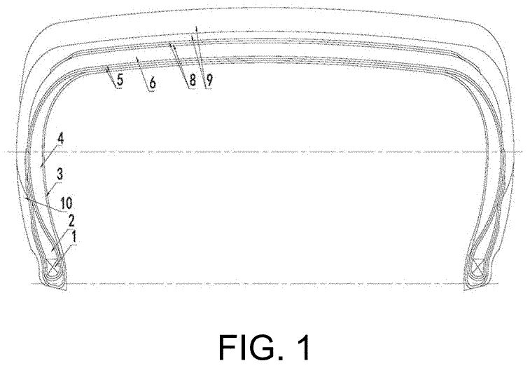

The embodiments of the present application will be further described in detail in conjunction with the accompanied drawings and specific examples. The term “inner” or “inside” in the specification means a position closer to the interior of the non-pneumatic tire, while the term “outer” or “outside” means a position closer to the exterior of the non-pneumatic tire. The terms “upper”, “lower”, “above” and “below” in the description are used to describe orientations or positions relative to a tire illustrated in FIG. 1 to FIG. 6.

In this application, a material of carcass cord can be nylon, polyester fiber, or aramid. A material of sidewall support layer can be rubber or polyurethane. A material of crown support layer can be, but not limited to, rubber, polyurethane, steel wire, or other elastic material, and the crown support layer has a certain thickness. A material of cushion ply can be nylon, polyester fiber, aramid or steel wire.

### Embodiment I

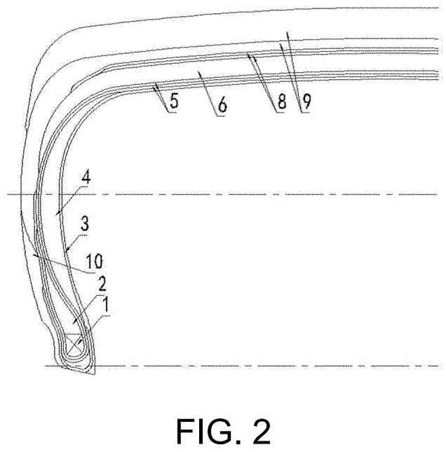

FIG. 1 and FIG. 2 illustrate embodiment I of the non-pneumatic tire of this application. As shown, the non-pneumatic tire includes beads 1, apexes 2, an inner liner 3, a cushion ply 8, a tread rubber 9, sidewall rubbers 10 and a first carcass ply 5. In addition, it includes sidewall support layers 4 and a crown support layer 6.

As shown, the inner liner 3 is located on the innermost side of the non-pneumatic tire. The sidewall support layers 4 are located at the locations of sidewalls of the non-pneumatic tire and interposed between the inner liner 3 and the first carcass ply 5. The apexes 2 are respectively located above the beads 1. Each apex 2 has a generally triangular cross section. Each apex 2 is partly overlapped with one sidewall support layer 4 with the first carcass ply 5 arranged between them. Both ends of the first carcass ply 5 respectively extend from the insides of the beads 1 to beneath the beads 1, and then to the outsides of the beads 1, so as to wrap the outsides of the apexes 2 and continue to extend up to the middle part of the sidewalls.

In this embodiment, the first carcass ply 5 comprises two layers of first carcass cords. The two layers of first carcass cords are mutually crosswise arranged. The cushion ply 8 is located at location of the crown of the non-pneumatic tire, and has two layers of cushion cords. The two layers of cushion cords are mutually crosswise arranged. The inner layer of cushion cord and the outer layer of carcass cord of the first carcass ply 5 are mutually crosswise arranged.

The tread rubber 9 is arranged at the location of the crown, and is the outermost layer. The sidewall rubbers 10 are arranged at the locations of the sidewalls, and are the outermost layers. The tread rubber 9 is arranged to have two layers. Two ends of the inner layer of the tread rubber 9 respectively extend downward from both sides of the crown, such that the two ends are respectively connected to the upper ends of the sidewall rubbers 10.

The crown support layer 6 is arranged between the first carcass ply 5 and the cushion ply 8. The two ends of the crown support layer 6 respectively extend toward the two sidewalls, and are respectively overlapped with the upper half parts of the sidewall support layers 4 with the first carcass ply 5 arranged between them.

In this embodiment, the crown support layer has a thickness of 5 mm.

The sidewall rubbers 10 and the tread rubber 9 can be formed of different rubber compounds (materials), such that the hardness of the sidewall rubbers 10 is slightly higher than that of the tread rubber 9 to ensure sufficient rigidity of rubbers of the sidewalls. Therefore, the supporting performance of the sidewalls is improved to a certain extent.

### Embodiment II

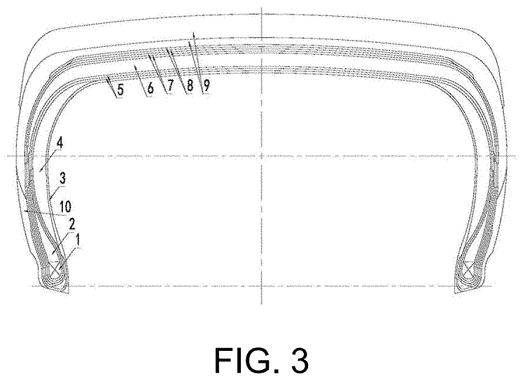

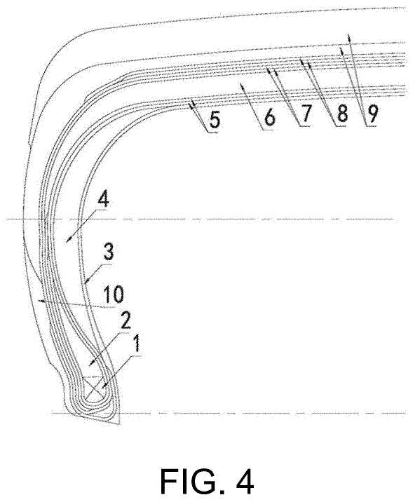

FIG. 3 and FIG. 4 illustrate embodiment II of the non-pneumatic tire of this application. Embodiment II is different from embodiment I in the following aspect. The non-pneumatic tire of embodiment II further includes a second carcass ply 7.

As shown, the sidewall support layers 4 are located at the locations of sidewalls of the non-pneumatic tire and interposed between the inner liner 3 and the first carcass ply 5. The first carcass ply 5 comprises two layers of carcass cords. The two layers of carcass cords are mutually crosswise arranged.

The second carcass ply 7 is arranged on the outside of the first carcass ply 5. The second carcass ply 7 has two layers of carcass cords. The two layers of carcass cords are mutually crosswise arranged. The inner layer of carcass cord of the second carcass ply 7 and the outer layer of carcass cord of the first carcass ply 5 are mutually crosswise arranged. Two ends of each layer of the carcass cord of the second carcass ply 7 respectively extend from both sides of the crown toward the two sidewalls, in particular, respectively extend from the outsides of the beads 1 to beneath the beads 1.

The crown support layer 6 is located at the location of the crown and between the first carcass ply 5 and the second carcass ply 7. Two ends of the crown support layer 6 respectively extend toward the sidewalls, such that the ends are partly overlapped with the sidewall support layers 4 with the first carcass ply 5 arranged between them. In the embodiment as shown, the two ends of the crown support layer 6 are respectively overlapped with the upper half parts of the sidewall support layers 4.

The cushion ply 8 is located at location of the crown of the non-pneumatic tire, is arranged the outside of the second carcass ply 7, and has two layers of cushion cords. The two layers of cushion cords are mutually crosswise arranged. The inner layer of cushion cord and the outer layer of carcass cord of the first carcass ply 7 are mutually crosswise arranged.

### Embodiment III

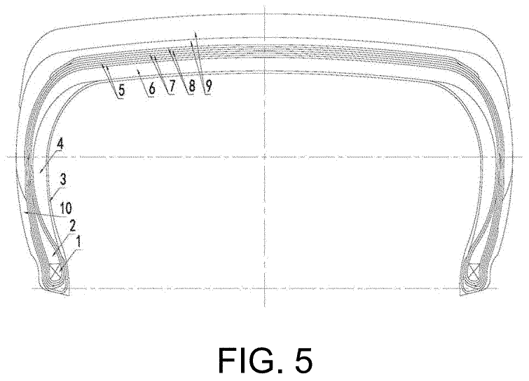

As shown in FIG. 5, embodiment III is different from embodiment II in the following aspects. The crown support layer 6 is arranged between the inner liner 3 and the first carcass ply 5. The two ends of the crown support layer 6 respectively extend to the two sidewalls, and are respectively overlapped with the upper half parts of the sidewall support layers 4. The first carcass ply 5, the second carcass ply 7 and the cushion ply 8 are arranged sequentially from inside to outside.

### Embodiment IV

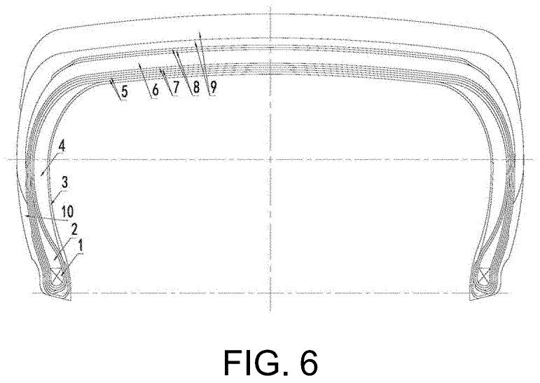

As shown in FIG. 6, embodiment IV is different from embodiment II in the following aspects. The crown support layer 6 is arranged between the second carcass 7 and the cushion ply 8. The two ends of the crown support layer 6 respectively extend to the two sidewalls, and are respectively overlapped with the upper half parts of the sidewall support layers 4 with the first carcass ply 5 and the second carcass ply 7 arranged between them.

### Embodiment V

Embodiment V is different from embodiment II in the following aspects. The first carcass ply 5 has one layer of carcass cord. The second carcass ply 7 has one layer of carcass cord. The cushion ply 8 has one layer of cushion cord.

### Embodiment VI

Embodiment VI is different from embodiment II in the following aspects. The first carcass ply 5 has two layers of carcass cord. The second carcass ply 7 has one layer of carcass cord.

The cushion ply 8 has two layers of cushion cord.

In the above embodiments, except the crown support layer and the sidewall support layers, the thicknesses of other plies or layers are similar to those of existing pneumatic tire. In addition, the thickness of each sidewall support layer is similar to that of existing run-flat tire.

The durability(index) and the amounts of static load sinkage of the above six embodiments, a conventional pneumatic tire and a conventional honeycomb tire are listed in Table 1.

TABLE 1

| | Conventional | Existing | | |
|---|---|---|---|---|
| | pneumatic tires | honeycomb tires | Embodiment I | Embodiment II |
| Location of the crown | — | — | Between 5 and 8 | Between 5 and 7 |
| support layer | | | | |
| Thickness of the crown | — | — | 5 mm | 5 mm |
| support layer | | | | |
| Locations of ends of the | — | — | The height of the overlap | The height of the overlap |
| crown support layer | | | portion overlapped with | portion overlapped with |
| | | | each sidewall support | each sidewall support |
| | | | layer is about one-half | layer is about one-half |
| | | | the height of each | the height of each |
| | | | sidewall support layer | sidewall support layer |
| Number of layers of | 2 | — | 2 | 2 |
| the first carcass ply | | | | |
| Number of layers of | 0 | — | 0 | 2 |
| the second carcass ply | | | | |
| Height of the turnup | About one third | — | About one half of | About one half of |
| | of the section | | the section height | the section height |
| | height | | | |
| Number of layers of | 0 | — | 2 | 2 |
| the cushion ply | | | | |
| Locations of ends of | Locations of the | — | Locations of the | Locations of the |
| the cushion ply | shoulders | | shoulders | shoulders |
| Thickness of the | — | — | 6.5 mm | 6.5 mm |
| thickest portion of | | | | |
| each sidewall support | | | | |
| layer | | | | |
| Height of the apexes | — | — | About one third of | About one third of |
| | | | the section height | the section height |
| Durability (index) | 5.0 | 4.4 | 4.8 | 4.9 |
| Comfort (index) | 5.0 | 4.0 | 4.7 | 4.7 |
| Traction (index) | 5.0 | 4.1 | 4.9 | 4.9 |
| Overall performance | 5.0 | 4.3 | 4.8 | 4.8 |
| (index) | | | | |

| | Embodiment III | Embodiment IV | Embodiment V | Embodiment VI |
|---|---|---|---|---|
| Location of the crown | Between 3 and 5 | Between 7 and 8 | Between 5 and 7 | Between 5 and 7 |
| support layer | | | | |
| Thickness of the crown | 5 mm | 5 mm | 5 mm | 5 mm |
| support layer | | | | |
| Locations of ends of | The height of the overlap | The height of the overlap | The height of the overlap | The height of the overlap |
| the crown support layer | portion overlapped with | portion overlapped with | portion overlapped with | portion overlapped with |
| | each sidewall support | each sidewall support | each sidewall support | each sidewall support |
| | layer is about one-half | layer is about one-half | layer is about one-half | layer is about one-half |
| | the height of each | the height of each | the height of each | the height of each |
| | sidewall support layer | sidewall support layer | sidewall support layer | sidewall support layer |
| Number of layers of the | 2 | 2 | 1 | 2 |
| first carcass ply | | | | |
| Number of layers of the | 2 | 2 | 1 | 1 |
| second carcass ply | | | | |
| Height of the turnup | About one half of | About one half of | About one half of | About one half of |
| | the section height | the section height | the section height | the section height |
| Number of layers of | 2 | 2 | 1 | 2 |
| the cushion ply | | | | |
| Locations of ends of | Locations of the | Locations of the | Locations of the | Locations of the |
| the cushion ply | shoulders | shoulders | shoulders | shoulders |
| Thickness of the | 6.5 mm | 6.5 mm | 6.5 mm | 6.5 mm |
| thickest portion of | | | | |
| each sidewall support | | | | |
| layer | | | | |
| Height of the apexes | About one third of | About one third of | About one third of | About one third of |
| | the section height | the section height | the section height | the section height |
| Durability (index) | 4.9 | 4.9 | 4.8 | 4.9 |
| Comfort (index) | 4.7 | 4.7 | 4.8 | 4.7 |
| Traction (index) | 4.9 | 4.9 | 4.9 | 4.9 |
| Overall performance | 4.8 | 4.8 | 4.8 | 4.8 |
| (index) | | | | |

In Table 1, “5” represents the first carcass ply, “7” represents the second carcass ply, “8” represents the cushion ply, and “section height” refers to half of the difference between the outer diameter of the non-pneumatic tire and the nominal diameter of the rim.

The datum in the table are compared and evaluated based on the performance of a conventional pneumatic tire. The higher values represent the better performances. It can be seen from the datum in the table that the non-pneumatic tire of the present application can provide comfort and traction similar to the existing pneumatic tire, and at the same time, the durability meets the requirements of use.

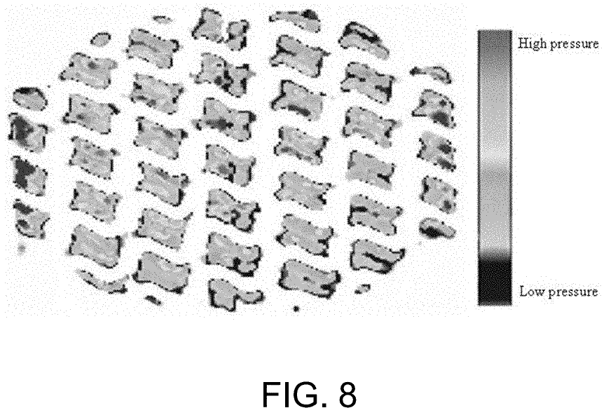

FIG. 8 is a view of the pressure distribution of an existing non-pneumatic tire in a normal use state. As shown in FIG. 8, the contour of the ground contact portion of the existing pneumatic tire is generally oval or substantially square. The ground contact area is large, so that sufficient traction can be provided, thereby obtaining excellent comfort and excellent stability.

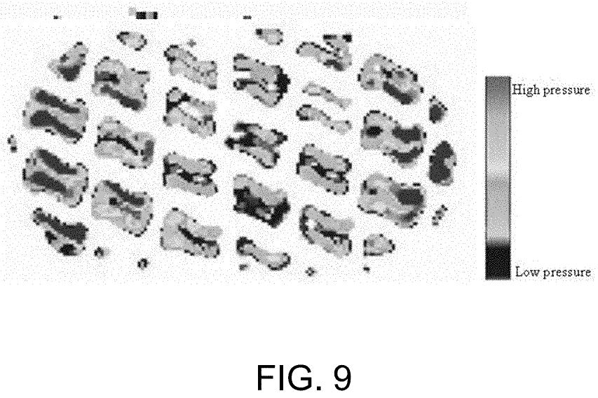

FIG. 9 is a view of the pressure distribution of an existing honeycomb tire in a normal use state. As shown in FIG. 9, the contour of the ground contact portion of the existing pneumatic tire is generally flat and substantially rectangular. The ground contact area is small, so that sufficient traction cannot be provided, thereby obtaining worse stability.

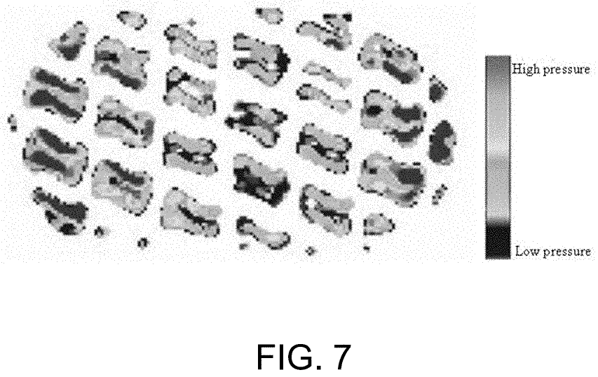

FIG. 7 is a view of the pressure distribution of the non-pneumatic tire of the present application in a normal use state. As shown in FIG. 7, the contour of the ground contact portion of the non-pneumatic tire of the present application has larger ground contact area, so that the contour of the ground contact portion is similar to that of the pneumatic tire. Therefore, sufficient traction, good stability and good comfort can be provided. Compared with a honeycomb tire, the non-pneumatic tire of the present application has lower pressure on the ground and less wear during use of the non-pneumatic tire, thus increasing service life.

The above embodiments intend to illustrate the application but not to limit its protection scope. It should be noted that, for those skilled in the art, various modifications and variations can be made to the application without departing from the spirit or scope of the application. Such modifications and variations are included in the protection scope of the application.

What is claimed is:

1. A non-pneumatic tire, comprising beads, apexes, an inner liner, a cushion ply, a tread rubber, sidewall rubbers and a first carcass ply, its characterized in that the non-pneumatic tire further comprises sidewall support layers and a crown support layer,
wherein the sidewall support layers are located at locations of sidewalls of the non-pneumatic tire and interposed between the inner liner and the first carcass ply, and
wherein the crown support layer is located at a location of a crown of the non-pneumatic tire, and interposed between the inner liner and the first carcass ply or between the first carcass ply and the cushion ply, and both ends of the crown support layer respectively extend toward the two sidewalls of the non-pneumatic tire.

2. The non-pneumatic tire according to claim 1, wherein the two ends of the crown support layer are respectively partly overlapped with the sidewall support layers.

3. The non-pneumatic tire according to claim 1, wherein the non-pneumatic tire further comprises a second carcass ply, and the second carcass ply is arranged between the first carcass ply and the cushion ply.

4. The non-pneumatic tire according to claim 3, wherein the first carcass ply, the second carcass ply and the cushion ply are arranged to have at least one layer of cord each.

5. The non-pneumatic tire according to claim 4, wherein both ends of the first carcass ply respectively extend to surround the beads from the inner sides of the beads and respectively continue to extend upward to wrap the beads and the apexes.

6. The non-pneumatic tire according to claim 5, wherein both ends of the second carcass ply respectively extend from both sides of the crown toward the two sidewalls to beneath the beads, or extend toward the insides of the beads to surrounds the beads.

7. The non-pneumatic tire according to claim 5, wherein the apexes are respectively partly overlapped with the sidewall support layers with the first carcass ply arranged between the apexes and the sidewall support layers.

8. The non-pneumatic tire according to claim 7, wherein the first carcass ply has at least two layers of carcass cords, and the at least two layers of carcass cords are mutually crosswise arranged.

9. The non-pneumatic tire according to claim 7, wherein the second carcass ply has at least two layers of carcass cords, and the at least two layers of carcass cords are mutually crosswise arranged, and
an inner layer of carcass cord of the second carcass ply and an outer layer of carcass cord of the first carcass ply are mutually crosswise arranged.

10. The non-pneumatic tire according to claim 7, wherein the cushion ply has at least two layers of cushion cords, and the at least two layers of cushion cords are mutually crosswise arranged, and
an inner layer of cushion cord and an outer layer of carcass cord of the second carcass ply are mutually crosswise arranged.
